(19) United States
(12) Patent Application Publication
(10) Pub. No.: US 2021/0046432 A1
(43) Pub. Date: Feb. 18, 2021

(54) PERMSELECTIVE MEMBRANE AND METHOD FOR PRODUCING SAME, AND METHOD FOR TREATING WATER

(71) Applicants: KURITA WATER INDUSTRIES LTD., Tokyo (JP); NATIONAL UNIVERSITY CORPORATION KOBE UNIVERSITY, Kobe-shi, Hyogo (JP)

(72) Inventors: Takahiro KAWAKATSU, Tokyo (JP); Yu FUJIMURA, Tokyo (JP); Hideto MATSUYAMA, Kobe-shi, Hyogo (JP); Daisuke SAEKI, Kobe-shi, Hyogo (JP); Kenta OKUNO, Kobe-shi, Hyogo (JP)

(21) Appl. No.: 16/977,618

(22) PCT Filed: Feb. 25, 2019
(86) PCT No.: PCT/JP2019/006993

§ 371 Date: Sep. 2, 2020

(30) Foreign Application Priority Data
Mar. 29, 2018 (JP) 2018-064460
Sep. 4, 2018 (JP) 2018-165418

(51) Int. Cl. B01D 71/82; B01D 69/02; B01D 69/10; B01D 69/12; B01D 71/56; B01D 71/74; C02F 1/44

(52) U.S. Cl. CPC B01D 71/82; B01D 69/02; B01D 69/10; B01D 69/12; B01D 71/56; C02F 2103/08; C02F 1/44; B01D 2323/36; B01D 2325/20; B01D 2325/24; B01D 71/74

(57) ABSTRACT

A permselective membrane is provided with a support membrane having selective permeability, and a coating layer formed on a surface of the support membrane and including a lipid bilayer membrane containing a channel substance. The support membrane includes a polyamide membrane providing permeation flux of 35 L/(m²·h) or more at a pressure of 0.1 MPa. A method for producing the permselective membrane includes a step of treating a polyamide membrane with chlorine to produce the support membrane and a step of forming the lipid bilayer membrane on the support membrane.

### TECHNICAL FIELD

The present invention relates to a permselective membrane used in the field of water treatment, in particular a permselective membrane having a coating layer comprising a lipid bilayer membrane. Furthermore, the present invention relates to a method for producing the permselective membrane and a method for treating water using the permselective membrane.

### BACKGROUND ART

In the fields of desalination of seawater and brine water, production of industrial water and ultrapure water, recovery of wastewater or the like, a reverse osmosis (RO) membranes is widely used as a permselective membrane. Treatment by an RO membrane has an advantage of being able to highly remove ions and low molecular weight organic components; on the other hand, it requires higher operating pressure than a microfiltration (MF) membrane and ultrafiltration (UF) membrane. In order to enhance water permeability of an RO membrane, improvements such as increasing of surface area by controlling a pleated structure of a skin layer have been attempted for example, for a polyamide RO membrane.

An RO membrane is fouled by organic components such as a biological metabolite contained in water to be treated. Since a fouled membrane has decreased water permeability, regular chemical cleaning is required, but separation performance reduces due to degradation of the membrane during cleaning.

As a method for suppressing fouling of a membrane, a method for coating a permselective membrane such as an RO membrane with a polymer having an amphoteric hydrophilic group similar to a phospholipid is known. A biomimetic surface is formed on the permselective membrane, and thus an effect of preventing fouling due to biological metabolites can be expected (PTL1).

In recent years, aquaporin which is a membrane protein selectively transferring water molecules attracts attentions as a water channel substance, and a possibility is suggested that a membrane incorporating this protein has higher water permeability than a conventional polyamide RO membrane (NPL1). However, NPL1 only shows water permeability of a high molecular weight endoplasmic reticulum comprising aquaporin, not of a membrane.

Examples of methods for producing a permselective membrane having a lipid bilayer membrane incorporating a water channel substance include a method in which a lipid bilayer membrane incorporating a water channel substance is sandwiched between porous supports, a method in which a lipid bilayer membrane is incorporated in a polymer, a method in which a lipid bilayer membrane is incorporated inside pores of a porous support, a method in which a lipid bilayer membrane is formed around a hydrophobic membrane, and the like (PTL2).

In the method in which a lipid bilayer membrane is sandwiched between the porous supports, the pressure resistance of the lipid bilayer membrane is enhanced. However, there exit problems: for example, the porous support itself which contacts with water to be treated is fouled; concentration polarization in the porous supports which results in significant reduction of rejection rate; and the porous support act as a resistance which may cause reduction of water permeability.

In the method in which a lipid bilayer membrane is incorporated in a polymer, the pressure resistance of the lipid bilayer membrane enhances, but there exist problems: for example, the function of the channel substance deteriorates during the process of incorporating the lipid bilayer membrane into the polymer; and the amount of the lipid bilayer membrane to be incorporated cannot be high.

In an RO membrane serving as a separating layer in which a surface of the membrane body having selective permeability is coated with a phospholipid bilayer membrane incorporating a water channel substance and the phospholipid bilayer membrane is in a state of being exposed, the problem to be solved is the pressure resistance of the phospholipid bilayer membrane.

PTL3 discloses that a cationic lipid is used so that the lipid is firmly supported on a nano-filtration (NF) membrane. When an NF membrane is a support membrane, the support membrane is dense and thus the pressure resistance is higher. However, there exists a problem that the permeability of the support itself is low, which results in low permeation flux of the obtained membrane.

PTL1: JP 6022827 B

PTL2: JP 5616396 B

PTL3: JP 6028533 B

NPL1: M. Kumar et al., Proceedings of the National Academy of Sciences, 104, 20719-20724 (2007).

### SUMMARY OF INVENTION

The object of the present invention is to provide a permselective membrane provided with a support membrane having selective permeability and a coating layer formed on a surface of the support membrane and comprising a lipid bilayer membrane containing a channel substance, wherein the permselective membrane has excellent pressure resistance to a pressure during water treatment and in addition provide high permeation flux in a process of obtaining permeated water, and a method for producing the permselective membrane, and to provide a method for treating water using the permselective membrane.

The present inventors investigated the problem described in PTL3 in order to solve the above problem. Specifically, in PTL3, the support membrane is a dense NF membrane and thus the pressure resistance is enhanced, however, there exist a problem that the water permeability of the NF membrane itself is low which results in low permeation flux of the obtained membrane. For example, the pure water permeation flux of the NF membrane used in PTL3 is 11 L/(m²·h) at a pressure of 0.1 MPa. Therefore, the pure water permeation flux of the permselective membrane obtained in the Example in which a lipid bilayer membrane containing a channel substance is supported on the NF membrane is 0.8 L/(m²·h) at a pressure of 0.1 MPa, and is no more than 1 LMH.

On the other hand, in the case of using an MF membrane or UF membrane as a support membrane under the same conditions as PTL3, the pressure resistance is 0.1 MPa or less when a lipid bilayer membrane containing a channel substance is supported on the membrane.

Therefore, the present inventors apply a polyamide membrane formed by interfacial polymerization as a support membrane of a lipid bilayer membrane containing a channel substance. The present inventors found that the pressure resistance can be enhanced while maintaining high permeation flux of the support membrane by adjusting the membrane forming conditions so that the pure water permeation flux of 35 L/(m²·h) or more at a pressure of 0.1 MPa can be obtained, and that a lipid bilayer membrane is formed due to electrostatic interaction by immersing the thus obtained support membrane in a suspension of liposome containing a lipid having a charge opposite to the membrane surface, and completed the present invention.

Specifically, summaries of the present invention are as follows.

[1] A permselective membrane provided with a support membrane having selective permeability and a coating layer formed on a surface of the support membrane and comprising a lipid bilayer membrane containing a channel substance, wherein the support membrane comprises a polyamide membrane providing a permeation flux of 35 L/(m²·h) or more at a pressure of 0.1 MPa.

[2] The permselective membrane according to [1], wherein the polyamide membrane has been treated with chlorine.

[3] The permselective membrane according to [1] or [2], wherein the lipid bilayer membrane contains a charged lipid.

[4] The permselective membrane according to [3], wherein the charged lipid is at least one selected from the group consisting of 1,2-dioleoyl-3-trimethylammoniumpropane, 1-palmitoyl-2-oleoyl-sn-glycero-3-ethylphosphocholine, 1-palmitoyl-2-oleoyl phosphatidylglycerol and 1-palmitoyl-2-oleoyl phosphatidic acid.

[5] The permselective membrane according to any one of [1] to [4], wherein the channel substance is at least one selected from the group consisting of gramicidin, amphotericin B and derivatives thereof.

[6] A method for producing the permselective membrane according to any one of [1] to [5] comprising a step of treating a polyamide membrane with chlorine to produce the support membrane and a step of forming the lipid bilayer membrane on the support membrane.

[7] A method for treating water, comprising a step of subjecting water to be treated to membrane separation treatment using the permselective membrane according to any one of [1] to [5].

### Advantageous Effects of Invention

[Mechanism of Action]

The mechanism of action of the present invention is as follows.

By using a polyamide membrane providing a permeation flux of 35 L/(m²·h) or more (at 0.1 MPa) as a support membrane of a permselective membrane provided with a support membrane having selective permeability and a coating layer formed on a surface of the support membrane and comprising a lipid bilayer membrane containing a channel substance, the permeation flux of the permselective membrane does not depend on the permeation flux of the support membrane, and a lipid bilayer membrane can be supported, and thus a permselective membrane having a high permeation flux and a high pressure resistance can be obtained.

Therefore, the permselective membrane of the present invention has a high water permeability and a high pressure resistance. The permselective membrane of the present invention is used as an RO membrane as well as a forward osmosis (FO) membrane.

### BRIEF DESCRIPTION OF DRAWINGS

FIG. 1 is a schematic illustrative drawing of the flat membrane testing apparatus used in Examples and Comparative Examples.

FIG. 2 is a vertical cross-sectional view of the flat membrane testing apparatus of FIG. 1.

FIG. 3 shows pressure dependency of the permeation flux and the salt rejection of the permselective membrane in Example 1.

### DESCRIPTION OF EMBODIMENTS

The permselective membrane of the present invention has a support membrane having selective permeability and a coating layer formed on a surface of the support membrane and comprising a lipid bilayer membrane containing a channel substance. The support membrane comprises a polyamide membrane providing permeation flux of 35 L/(m²·h) or more at a pressure of 0.1 MPa.

[Support Membrane]

The support membrane used in the present invention is a polyamide membrane providing a permeation flux of 35 L/(m²·h) or more (at 0.1 MPa).

Examples of methods for cationizing the surface potential of a polyamide membrane used as a support membrane in order to form a lipid bilayer membrane described below include a method in which after forming a polyamide membrane by interfacial polymerization of an acid chloride compound and an amine compound, excessive chloride is reacted with trimethylamine, dimethylamine, etc. to produce a quaternary amine or a tertiary amine etc., and a method in which a cationic polymer such as polyethyleneimine, polyvinyl amidine and poly(diallyl dimethylammonium chloride) is adsorbed to a polyamide membrane to modify the polyamide membrane. Examples of methods for anionizing the surface potential of a polyamide membrane include a method in which after forming a polyamide membrane by interfacial polymerization of an acid chloride compound and an amine compound, excessive amine is reacted with epichlorohydrin to introduce an epoxy group, which is then reacted with sodium sulfite to obtain a sulfone group, and a method in which the polyamide membrane is brought into contact with sodium hypochlorite to produce a carboxy group.

In the present invention, a polyamide membrane having such a surface potential wherein the polyamide membrane provide permeation flux of 35 L/(m²·h) or more (at 0.1 MPa) is used.

The polyamide membrane providing such a high permeation flux can be obtained, for example, by treating a polyamide membrane with chlorine to adjust the permeation flux.

Specifically, the permeation flux of a usual polyamide membrane without chlorine treatment is about 5 L/(m²·h) (at 0.1 MPa), and the polyamide membrane providing a permeation flux of 35 L/(m²·h) or more (at 0.1 MPa) can be obtained by treating such a polyamide membrane with chlorine to enhance the permeation flux.

Examples of methods for chlorine treatment include a method in which a polyamide membrane is immersed in an aqueous solution of hypochlorite such as sodium hypochlorite and/or hypochlorous acid having a concentration of about 0.5-20 g/L (effective chlorine concentration 0.2-10 g/L). The immersion time is not particularly limited, but preferably about 1-24 hours from the viewpoint of the effect of chlorine treatment and productivity.

By adjusting the concentration of chlorite and/or hypochlorite and the immersion time in the aqueous solution of hypochlorite and/or hypochlorous acid used for this chlorine treatment therein, the permeation flux of the polyamide membrane after chlorine treatment can be adjusted. Specifically, it is likely that when the concentration of chlorite and/or hypochlorite is higher or the immersion time is longer, the permeation flux of the polyamide membrane after chlorine treatment can be higher.

By treating a polyamide membrane with chlorine as described above, the permeation flux can be enhanced. Furthermore, an effect of providing an anionic surface potential due to generation of carboxy groups can also be obtained by chlorine treatment.

After chlorine treatment of the polyamide membrane, cleaning/hydrolysis treatment is preferably conducted in which the membrane is immersed in an alkali aqueous solution of sodium hydroxide etc. having a concentration of about 0.001 to 1 mol/L for removal of decomposition products and hydrolysis.

The permeation flux of the polyamide membrane used as a support membrane in the present invention may be 35 L/(m²·h) or more (at 0.1 MPa), but is preferably 45 L/(m²·h) or more (at 0.1 MPa) from the viewpoint of enhancement of the permeation flux of the obtained permselective membrane. On the other hand, when the size of pores is larger, pressure resistance cannot be obtained, and thus the permeation flux of the polyamide membrane is preferably 1000 L/(m²·h) or less (at 0.1 MPa).

[Lipid Bilayer Membrane]

Examples of methods for forming a lipid bilayer membrane on the surface of the above support membrane include Langmuir-Blodgett method and liposome fusion method. In liposome fusion method, a lipid bilayer membrane is formed on the support membrane due to electrostatic interaction by immersing the support membrane obtained as described above in a dispersion of a liposome containing a charged lipid having a charge opposite to the membrane surface.

As methods for preparing a liposome, common methods such as gentle hydration method, ultrasonic method and extrusion method can be used, but since a unilamellar liposome is preferably used from the viewpoint of uniform film forming, extrusion method is preferably used which enables easy preparation of a unilamellar liposome.

A lipid constituting the liposome is not particularly limited, but preferably contains an anionic lipid when the surface potential of the polyamide membrane obtained as described above is cationic, or preferably contains a cationic lipid when the surface potential is anionic. A neutral lipid is preferably contained within the range of 10-90 mol % from the viewpoint of stability of the liposome and film-formability.

An anionic lipid is not particularly limited, but 1-palmitoyl-2-oleoyl phosphatidylglycerol, 1,2-dioleoyl phosphatidylglycerol, 1,2-dipalmitoyl phosphatidylglycerol, 1-palmitoyl-2-oleoyl phosphatidic acid, 1,2-dioleoyl phosphatidic acid, 1,2-dipalmitoyl phosphatidic acid, 1-palmitoyl-2-oleoyl phosphatidylserine, 1,2-dioleoyl phosphatidylserine, 1,2-dipalmitoyl phosphatidylserine, 1-palmitoyl-2-oleoyl phosphatidylinositol, 1,2-dioleoyl phosphatidylinositol, 1,2-dipalmitoyl phosphatidylinositol, 1′,3′-bis[1,2-dioleoyl-sn-glycero-3-phospho]-sn-glycerol, 1′,3′-bis[1,2-dipalmitoyl-sn-glycero-3-phospho]-sn-glycerol etc. can be used.

A cationic lipid is not particularly limited, but 1,2-dioleoyl-3-trimethylammoniumpropane, 1, 2-palmitoyl-3-trimethylammoniumpropane, 1-palmitoyl-2-oleoyl-sn-glycero-3-ethylphosphocholine, 1,2-dioleoyl-sn-glycero-3-ethylphosphocholine, 1,2-dipalmitoyl-sn-glycero-3-ethylphosphocholine, 3β-[N-(N′,N′-dimethylaminoethane)-carbamoyl]cholesterol hydrochloride etc. can be used.

A neutral lipid is not particularly limited, but 1-palmitoyl-2-oleoyl phosphatidylcholine, 1,2-dioleoyl phosphatidylcholine, 1,2-dipalmitoyl phosphatidylcholine, 1,2-dilauroyl-sn-glycero-3-phosphorylcholine, 1-palmitoyl-2-oleoyl phosphatidylethanolamine, 1,2-dioleoyl phosphatidylethanolamine, 1,2-dipalmitoyl phosphatidylethanolamine, cholesterol, ergosterol etc. can be used.

These anionic lipids, cationic lipids and neutral lipids may be respectively used alone, or may be used in the form of a mixture of two or more.

Among these lipids, 1,2-dioleoyl-3-trimethylammoniumpropane, 1-palmitoyl-2-oleoyl-sn-glycero-3-ethylphosphocholine, 1-palmitoyl-2-oleoyl phosphatidylglycerol and 1-palmitoyl-2-oleoyl phosphatidic acid are preferably used as a charged lipid from the viewpoint of formation of a channel having high activity.

[Channel Substance]

As a channel substance, aquaporin, gramicidin, amphotericin B or derivatives thereof, preferably gramicidin, amphotericin B or derivatives thereof etc. can be used. The channel substances may be used alone or in the form of a mixture of two or more.

As a method for introducing a channel substance to a liposome, a method in which the channel substance is previously mixed in the step of liposome preparation, a method in which the channel substance is added after film forming, and the like can be used.

When a lipid bilayer membrane is formed by liposome fusion method, at first a lipid is dissolved in a solvent preferably along with a channel substance. As a solvent, chloroform, chloroform/methanol mixture etc. can be used.

The mixing ratio of the lipid and the channel substance is suitably such level that the ratio of the channel substance based on the total of both is 1-20 mol %, particularly 3-10 mol %.

Next, a 0.25-10 mM, in particular 0.5-5 mM solution of the lipid and the channel substance is prepared and dried under reduced pressure to obtain a dry lipid membrane. To the dry membrane, pure water is added, and the membrane is heated to a temperature higher than the phase transition temperature of the lipid, and thus a dispersion of the liposome having a shape of a spherical shell is obtained.

The average particle size of the liposome in the liposome dispersion used in the present invention is preferably 0.05-5μm, particularly preferably 0.05-0.4μm.

This liposome dispersion is brought into contact with a support membrane, and by maintaining the support membrane in contact with the liposome dispersion for about 1-50 hours, in particular 20-30 hours, the liposome is adsorbed on the surface of the support membrane to form a coating layer of the lipid bilayer membrane. Then, a permselective membrane having the coating layer of the lipid bilayer membrane on the support membrane is obtained by taking out the support membrane with the coating layer from the solution, removing excess lipid by an acid or an alkali if needed and then washing the membrane with ultrapure water or pure water.

The thickness of the lipid bilayer membrane is preferably 1 to 10 layers, in particular 1 to 3 layers. A substance having a charge opposite to that of the phospholipids, such as polyacrylic acid, polystyrene sulfonic acid, tannic acid, polyamino acid, polyethyleneimine and chitosan, may be adsorbed on the surface of this lipid bilayer membrane.

When the permselective membrane of the present invention is used to obtain permeated water in RO membrane treatment or FO membrane treatment, the water permeate flow rate of 2 L/(m²·h) or more can be achieved at a driving pressure within a range of 0.05-3 MPa.

As an application of the permselective membrane of the present invention, in addition to desalting treatment of seawater and brine water and purification treatment of industrial water, sewage water and tap water, applications such as concentration of a fine chemicals, pharmaceuticals and foods may be exemplified. The temperature of water to be treated is preferably about 10-40° C., in particular 15-35° C.

### EXAMPLES

Hereinafter, Examples and Comparative Examples will be described. First, materials and a producing method of a support membrane and a permselective membrane, and evaluation methods of the permselective membrane will be described.

[Membrane Body]

As a membrane body, a polyamide membrane (ES20, manufactured by Nitto Denko Corporation), or a polyamide membrane (XLE-440, manufactured by Dow FilmTec Corporation) was used.

[Lipid]

As a cationic lipid, 1,2-dioleoyl-3-trimethylammoniumpropane (DOTAP, manufactured by NOF CORPORATION) was used.

As a neutral lipid, 1-palmitoyl-2-oleoyl phosphatidylcholine (POPC, manufactured by NOF CORPORATION), ergosterol (manufactured by Tokyo Chemical Industry Co., Ltd.) or 1,2-dilauroyl-sn-glycero-3-phosphorylcholine (DLPC, manufactured by NOF CORPORATION) was used.

[Channel Substance]

As a channel substance, gramicidin A (GA, manufactured by Sigma-Aldrich Co. LLC.) or amphotericin B (AmB, manufactured by Cayman Chemical Company) was used.

[Preparation of Liposome Dispersion I]

A lipid was dissolved in chloroform, GA dissolved in trifluoroethanol was mixed with this solution so that GA concentration of 5 mol % based on lipid was obtained, an organic solvent was evaporated using an evaporator, pure water was added to the dried lipid thin film remained in the container to hydrate the lipid at 45° C., and thus a liposome dispersion was prepared. The obtained liposome dispersion was subjected to grain growth by freezing and thawing method in which alternating immersion in liquid nitrogen and a hot water bath at 45° C. was repeated 5 times, then subjected to extrusion sizing using a track-etched polycarbonate membrane having a pore size of 0.1μm (Nuclepore, manufactured by GE Healthcare Japan Corporation), and diluted by pure water to obtain the lipid concentration of about 0.4 mmol/L, and thus liposome dispersion I for testing was obtained.

[Preparation of Liposome Dispersion II]

Ergosterol, DLPC and DOTAP as lipids were dissolved in chloroform, AmB dissolved in trifluoroethanol was mixed with this solution, and an organic solvent was evaporated using an evaporator. Pure water was added to the dried lipid thin film remained in the container to hydrate the lipid at 45° C., and thus a liposome dispersion was prepared. The obtained liposome dispersion was subjected to grain growth by freezing and thawing method in which alternating immersion in liquid nitrogen and a hot water bath at 45° C. was repeated 5 times, then subjected to extrusion sizing using a track-etched polycarbonate membrane having a pore size of 0.1μm (Nuclepore, manufactured by GE Healthcare Japan Corporation), and diluted by pure water to obtain the lipid concentration of about 0.4 mmol/L, and thus liposome dispersion II for testing was obtained.

The obtained liposome dispersion II contains 10 mol % of AmB, 10 mol % of ergosterol, 75 mol % of DLPC, 5 mol % of DOTAP based on the total amount of the lipids and the channel substance.

[Preparation of Polyamide Support Membrane I]

A membrane body (polyamide membrane (ES20, manufactured by Nitto Denko Corporation) was immersed in an aqueous solution of sodium hypochlorite (pH7.0) having a predetermined concentration for 1 hour, and then immersed in 0.1 mol/L aqueous solution of sodium hydroxide for 16 hours to produce the polyamide support membrane I.

[Preparation of Polyamide Support Membrane II]

A membrane body (polyamide membrane (XLE-440, manufactured by Dow FilmTec Corporation)) was immersed in an aqueous solution of sodium hypochlorite (pH7.0) having a predetermined concentration for 1 hour, and then immersed in 0.1 mol/L aqueous solution of sodium hydroxide for 16 hours to produce the polyamide support membrane II.

[Formation of Lipid Bilayer Membrane Layer]

The above polyamide support membrane I or II is immersed in the liposome dispersion I or II for 24 hours at room temperature and washed with pure water to form a lipid bilayer membrane layer.

[Evaluation of Permselective Membrane]

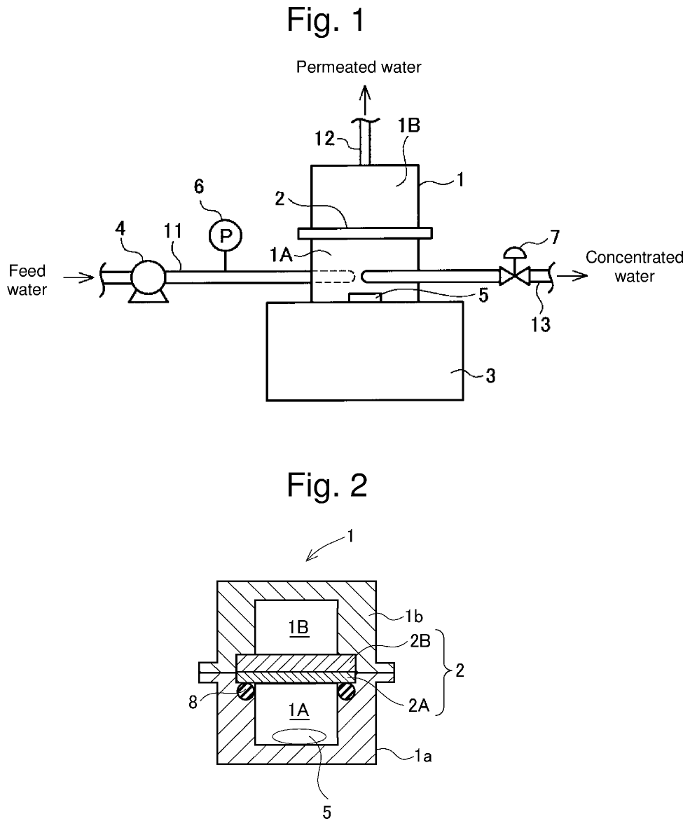

The pressure resistance of the permselective membrane was evaluated using the flat membrane testing apparatus shown in FIG. 1 and FIG 2.

In this flat membrane testing apparatus, membrane feed-water is supplied to the feed water room 1A under the flat membrane cell 2, which is installed in the sealed container 1 and to which the membrane under test (diameter 2 cm) is attached, using the high-pressure pump 4 through the pipe 11. As shown in FIG. 2, the sealed container 1 is constituted with the lower case la for the feed water room 1A and the upper case 1b for the permeated water room 1B, and the flat membrane cell 2 is fixed via the O ring 8 between the lower case la and the upper case 1b. The flat membrane cell 2 has a structure in which the permeated water side of the membrane under test 2A is supported on the porous support plate 2B. The inside of the feed water room 1A under the flat membrane cell 2 is stirred by spinning the stirring element 5 using the stirrer 3. The water permeated through the membrane passes through the permeated water room 1B above the flat membrane cell 2 and is taken out via the pipe 12. The concentrated water is taken out via the pipe 13. The pressure inside the sealed container 1 is regulated using the pressure gauge 6 provided on the feed-water pipe 11 and the pressure regulating valve 7 provided on the pipe 13 for taking out concentrated water.

The pressure applied to the membrane surface is regulated to 0-1.2 MPa using the pressure regulating valve 7. Pure water was used as a feed solution in the case of evaluating the pure water permeation flux, and 0.05 wt % aqueous solution of sodium chloride (NaCl) or 0.05 wt % aqueous solution of magnesium sulfate (MgSO₄) was used as a feed solution in the case of evaluating the salt rejection. The pure water permeation flux was obtained from the weight change of the permeated water when pure water was passed. Furthermore, the salt rejection was obtained using the following formula from the electric conductivity of the concentrated water and the permeated water when the aqueous solution of sodium chloride or 0.05 wt % aqueous solution of magnesium sulfate (MgSO₄) was passed.

Salt rejection=(1-electric conductivity of permeated water/electric conductivity of concentrated water)×100

### Example 1

On the polyamide support membrane I produced using 10 g/L aqueous solution of sodium hypochlorite, a lipid bilayer membrane layer was formed using the liposome dispersion I in which DOTAP and POPC was mixed in the ratio of 25:75 (molar ratio) to produce a permselective membrane. The permeation flux and the salt rejection of the obtained permselective membrane were measured, and in addition, the pressure dependency thereof was investigated.

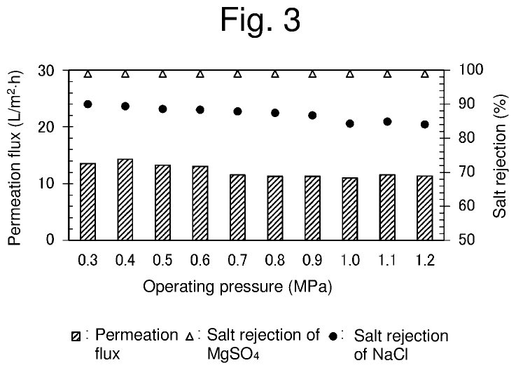

The pure water permeation flux and the salt rejection of NaCl at an operating pressure of 0.1 MPa are shown in Table 1. Furthermore, the results of investigating the pressure dependencies of the permeation flux and the salt rejection (salt rejection of NaCl, salt rejection of MgSO₄) by varying the operating pressure from 0.3 to 1.2 MPa are shown in FIG. 3.

### Example 2

A permselective membrane was produced in a similar way to Example 1 except that 10 mol % of GA was added when the liposome dispersion was prepared and the liposome dispersion I prepared using only DOTAP as a lipid was used. The pure water permeation flux and the salt rejection of NaCl for the obtained permselective membrane at an operating pressure of 0.1 MPa are shown in Table 1.

### Comparative Example 1

A permselective membrane was produced in a similar way to Example 1 except that the polyamide support membrane I prepared using 2 g/L aqueous solution of sodium hypochlorite was used. The pure water permeation flux and the salt rejection of NaCl for the obtained permselective membrane at an operating pressure of 0.1 MPa are shown in Table 1.

### Comparative Example 2

A permselective membrane was produced in a similar way to Example 1 except that a nitrocellulose MF membrane (VSWP, manufactured by Millipore Company) having a pore size of 0.025μm was used as a support membrane instead of the polyamide support membrane I. The pure water permeation flux and the salt rejection of NaCl for the obtained permselective membrane at an operating pressure of 0.1 MPa are shown in Table 1.

### Comparative Example 3

A permselective membrane was produced in a similar way to Example 1 except that a sulfonated polyethersulfone NF membrane (NTR7450, manufactured by Nitto Denko Corporation) having a pure water permeation flux of 8.8 L/(m²·h) at a pressure of 0.1 MPa was used as a support membrane instead of the polyamide support membrane I. The pure water permeation flux and the salt rejection of NaCl for the obtained permselective membrane at an operating pressure of 0.1 MPa are shown in Table 1.

### Comparative Example 4

A permselective membrane was produced in a similar way to Example 1 except that the liposome dispersion I comprising DOTAP only and prepared without GA was used. The pure water permeation flux and the salt rejection of NaCl for the obtained permselective membrane at an operating pressure of 0.1 MPa are shown in Table 1.

In Table 1, the values of the pure water permeation flux at an operating pressure of 0.1 MPa measured using the flat membrane testing apparatus shown in FIG. 1 and FIG. 2 similarly to the permeation flux of the permselective membrane are also shown for the support membrane used in each Example and Comparative Example.

TABLE 1

| | | Evaluation results of permselective | |
|---|---|---|---|
| | Pure water | membrane (0.1 MPa) | |
| | permeation flux | Pure water | |
| | (0.1 MPa) (L/m² · h) | permeation | Salt rejection of |
| | of support membrane | flux (L/m² · h) | NaCl (%) |
| Example 1 | 50 | 14 | 90.1 |
| Example 2 | 50 | 23 | 70.2 |
| Comparative | 14 | 1.2 | 96 |
| Example 1 | | | |
| Comparative | 259 | 216 | 0 |
| Example 2 | | | |
| Comparative | 8.8 | 0.052 | * |
| Example 3 | | | |
| Comparative | 50 | 1.5 | 89.3 |
| Example 4 | | | |

* Unmeasurable due to quite low water permeability

The following can be seen from the results of Examples 1, 2 and Comparative Examples 1 to 4.

In Comparative Example 1, since the pure water permeation flux of the support membrane is as low as 14 L/(m²·h) at a pressure of 0.1 MPa, high pure water permeation flux is not obtained also for the permselective membrane produced using this support membrane.

In Comparative Example 2, since the support membrane is a porous membrane, the lipid bilayer membrane layer is not sufficiently covered and the salt rejection is not obtained.

In Comparative Example 3, since the pure water permeation flux of the support membrane is as low as 8.8 L/(m²·h) at a pressure of 0.1 MPa similarly to Comparative Example 1, high pure water permeation flux is not obtained also for the permselective membrane produced using this support membrane.

In Comparative Example 4, since a channel substance is not added, high pure water permeation flux is not obtained also for the permselective membrane produced using this support membrane.

On the other hand, in Example 1, sufficient pure water permeation flux and salt rejection is obtained. In Example 2, further higher pure water permeation flux is obtained by increasing the concentration of the channel substance

In FIG. 3, it can be seen that both the water permeability and the salt rejection of the permselective membrane produced in Example 1 are maintained constant even at 1.2 MPa and that the membrane has pressure resistance. In the permselective membrane of Example 1, a chlorine-treated polyamide membrane having high water permeability and a dense surface was used as a support membrane, and thus it is considered that high water permeability due to the channel substance could be obtained while maintaining the structure of the lipid bilayer membrane formed on the surface. Specifically, the zeta potential of the surface of the polyamide membrane was −10 mV or less due to carboxyl groups generated by chlorine treatment, and thus it is considered that channel substance-containing lipid bilayer membrane having a cationic surface potential due to DOTAP was stably formed by electrostatic interaction.

### Example 3

A permselective membrane was produced in the similar way to Example 1 except that the polyamide support membrane II produced using 20 g/L aqueous solution of sodium hypochlorite was used. The pure water permeation flux and the salt rejection of NaCl for the obtained permselective membrane at an operating pressure of 0.1 MPa are shown in Table 2.

### Example 4

A permselective membrane was produced in the similar way to Example 3 except that the liposome dispersion I in which DOTAP and POPC were mixed in the ratio of 5:95 (molar ratio) was used. The pure water permeation flux and the salt rejection of NaCl for the obtained permselective membrane at an operating pressure of 0.1 MPa are shown in Table 2.

### Example 5

A permselective membrane was produced in the similar way to Example 3 except that the liposome dispersion II was used instead of the liposome dispersion I. The pure water permeation flux and the salt rejection of NaCl for the obtained permselective membrane at an operating pressure of 0.1 MPa are shown in Table 2.

In Table 2, the pure water permeation flux at an operating pressure of 0.1 MPa measured using the flat membrane testing apparatus shown in FIG. 1 and FIG. 2 similarly to the permeation flux of the permselective membrane are also shown for the support membrane used in each Example.

TABLE 2

| | | Evaluation results of permselective | |
|---|---|---|---|
| | Pure water | membrane (0.1 MPa) | |
| | permeation flux | Pure water | |
| | (0.1 MPa) (L/m² · h) | permeation | Salt rejection of |
| | of support membrane | flux (L/m² · h) | NaCl (%) |
| Example 3 | 79 | 9.1 | 94.7 |
| Example 4 | 79 | 12.0 | 93.0 |
| Example 5 | 79 | 16.4 | 74.3 |

The following can be seen from the results of Examples 3-5.

In Examples 3 and 4, though the permselective membrane was produced using the polyamide membrane different from the polyamide membrane which was a membrane body used in Example 1, high pure water permeation flux and salt rejection were obtained similarly to Example 1.

In Example 5, though the permselective membrane was produced using a channel substance and the membrane body which were different from those of Example 1, high pure water permeation flux and salt rejection were obtained similarly to Example 1.

As clearly can be seen from the above Examples, a channel substance and a polyamide membrane used in the present invention are not particularly limited to the specific ones.

As clearly can be seen from the above Examples and Comparative Examples, according to the present invention, a phospholipid membrane containing a channel substance can be stably supported on a support membrane having excellent water permeability, and high water permeability and pressure resistance can be obtained. As a result, the obtained membrane can be used as an RO membrane or an FO membrane.

The specific embodiments of the present invention have been described in detail, however, it is clear to those skilled in the art that various modifications can be made without departing form the spirit and scope of the present invention.

The present application is based on JP 2018-064460 filed on Mar. 29, 2018 and JP 2018-165418 filed on Sep. 4, 2018, the entire contents of which is incorporated by reference.

### REFERENCE SIGNS LIST

1 Sealed container
1A Feed water room
1B Permeated water room
2 Flat membrane cell
2A Membrane under test
2B Porous support plate
6 Pressure gauge
7 Pressure regulating valve

1. A permselective membrane provided with a support membrane having selective permeability and a coating layer formed on a surface of the support membrane and comprising a lipid bilayer membrane containing a channel substance, wherein the support membrane comprises a polyamide membrane providing a permeation flux of 35 L/(m²·h) or more at a pressure of 0.1 MPa.

2. The permselective membrane according to claim 1, wherein the polyamide membrane provides a permeation flux of 35-1000 L/(m²·h) at a pressure of 0.1 MPa.

3. The permselective membrane according to claim 1, wherein the polyamide membrane has been treated with chlorine.

4. The permselective membrane according to claim 1, wherein the lipid bilayer membrane contains a charged lipid.

5. The permselective membrane according to claim 4, wherein the charged lipid is at least one selected from the group consisting of 1,2-dioleoyl-3-trimethylammoniumpropane, 1-palmitoyl-2-oleoyl-sn-glycero-3-ethylphosphocholine, 1-palmitoyl-2-oleoyl phosphatidylglycerol and 1-palmitoyl-2-oleoyl phosphatidic acid.

6. The permselective membrane according to claim 1, wherein the channel substance is at least one selected from the group consisting of gramicidin, amphotericin B and derivatives thereof.

7. A method for producing the permselective membrane according to claim 1, comprising a step of treating a polyamide membrane with chlorine to produce the support membrane and a step of forming the lipid bilayer membrane on the support membrane.

8. A method for treating water, comprising a step of subjecting water to be treated to membrane separation treatment using the permselective membrane according to claim 1.
